(19) United States
(12) Patent Application Publication
(10) Pub. No.: US 2004/0239818 A1
(43) Pub. Date: Dec. 2, 2004

(54) Laser apparatus and a projection video display unit

(75) Inventors: Tooru Sugiyama, Kumagaya-shi (JP); Ken Ito, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/802,045

(22) Filed: Mar. 17, 2004

(30) Foreign Application Priority Data
Mar. 18, 2003 (JP) 2003-074126

(51) Int. Cl. H01S 3/10; H01S 3/13; H01S 3/04; H04N 3/22; H04N 3/26

(52) U.S. Cl. 348/745

(57) ABSTRACT

A video display unit according to the present invention uses a plurality of semiconductor lasers as one light source. The unit lowers all laser outputs when lowering the brightness of the semiconductor lasers and realizes a long life, and stops one of the semiconductor lasers when realizing a low power consumption mode. Thus, a long life is realized when lowering all laser outputs, and a low power consumption is realized when stopping some semiconductor lasers.

### CROSS-REFERENCE TO RELATED APPLICATIONS

This application is based upon and claims the benefit of priority from prior Japanese Patent Application No. 2003-74126, filed Mar. 18, 2003, the entire contents of which are incorporated herein by reference.

### BACKGROUND OF THE INVENTION

1. Field of the Invention

The present invention relates to a laser apparatus which uses a plurality of semiconductor laser as one light source, and a projection video display unit using the laser apparatus.

2. Description of the Related Art

Jpn. Pat. Appln. KOKAI Publication No. 2000-267621 discloses an example of a projection video display unit which uses a laser apparatus as a light source of a projection vide display unit. In the projection vide display unit described in Jpn. Pat. Appln. KOKAI Publication No. 2000-267621, a technique to use a plurality of laser apparatus as one light source is described. However, there is a problem in the light source using the laser apparatus, that is, the life is short and the power consumption is large.

### BRIEF SUMMARY OF THE INVENTION

According to an aspect of the present invention, there is provided a laser apparatus comprising:

a plurality of laser output means, each laser output means obtaining a single optical output synthesized with the laser outputs from a plurality of laser oscillators; and control means lowering the whole optical output by adjusting the optical outputs of all of the plurality of laser oscillators of the plurality of laser output means, when a long life mode is set, and lowering the whole optical output by stopping the outputs of some of the plurality of laser oscillators in the plurality of laser output means, when a low power consumption mode is set.

Further an aspect of the present invention, there is provided a projection video display unit which modulates R (red), G (green) and B (blue) lights in space modulation elements, synthesizes the space modulated lights, and projects the synthesized light and forms an image on a screen by using an optical means, comprising:

laser output means for the R (red), G (green) and B (blue) lights, each laser output means obtaining a single optical output synthesized with the laser outputs from a plurality of laser oscillators;

detection means provided in each laser output means, and detecting the quantity of the light outputted from said plurality of laser oscillators; and

control means, the control means lowering the optical outputs of all of the laser oscillators in the non-failed laser output means for the other colors, decreasing the brightness of a display image, and maintaining the balance of R, G and B optical outputs, when an error occurs in any of the laser oscillators in the laser output means.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a schematic diagram explaining a first embodiment of the present invention;

FIG. 2 is a schematic diagram explaining an example of the essential part of the projection video display unit shown in FIG. 1;

FIG. 3A is a schematic diagram showing an example of control state of an optical module incorporated in the unit shown in FIGS. 1 and 2, explaining an example of control in a steady state;

FIG. 3B is a schematic diagram showing an example of control of an optical module incorporated in the unit shown in FIGS. 1 and 2, explaining an example of control to realize a long life light source;

FIG. 3C is a schematic diagram showing an example of control of an optical module incorporated in the unit shown in FIGS. 1 and 2, explaining an example of control to realize a low power consumption light source;

FIG. 3D is a schematic diagram showing an example of control of an optical module incorporated in the unit shown in FIGS. 1 and 2, explaining another example of control to realize a low power consumption source;

FIG. 4 is a schematic diagram explaining an example of display state of a display used for changing the modes in the present invention;

FIGS. 5A and 5B are schematic diagrams showing another example of control of an optical module of the present invention, explaining an example of control as a long life mode when some light sources fail;

FIGS. 6A and 6B are schematic diagrams showing another example of control of an optical module of the present invention, explaining an example of control as a low power consumption mode when some light sources fail;

FIG. 7 is a schematic diagram explaining another example of the essential part of the projection video display unit shown in FIG. 1;

FIG. 8 is a schematic diagram explaining still another example of the essential part of the projection video display unit shown in FIG. 1; and

FIG. 9 is a flow chart showing an example of control operation of the projection video display unit shown in FIG. 1.

### DETAILED DESCRIPTION OF THE INVENTION

Hereinafter, embodiments of the present invention will be explained in detail with reference to the attached drawings.

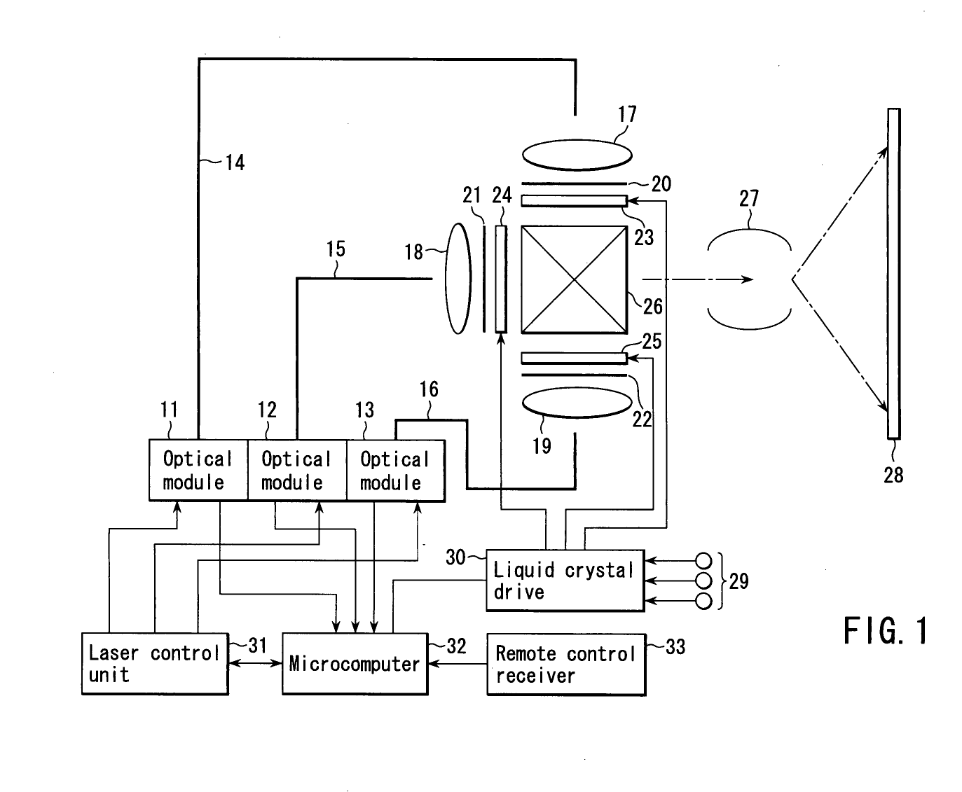

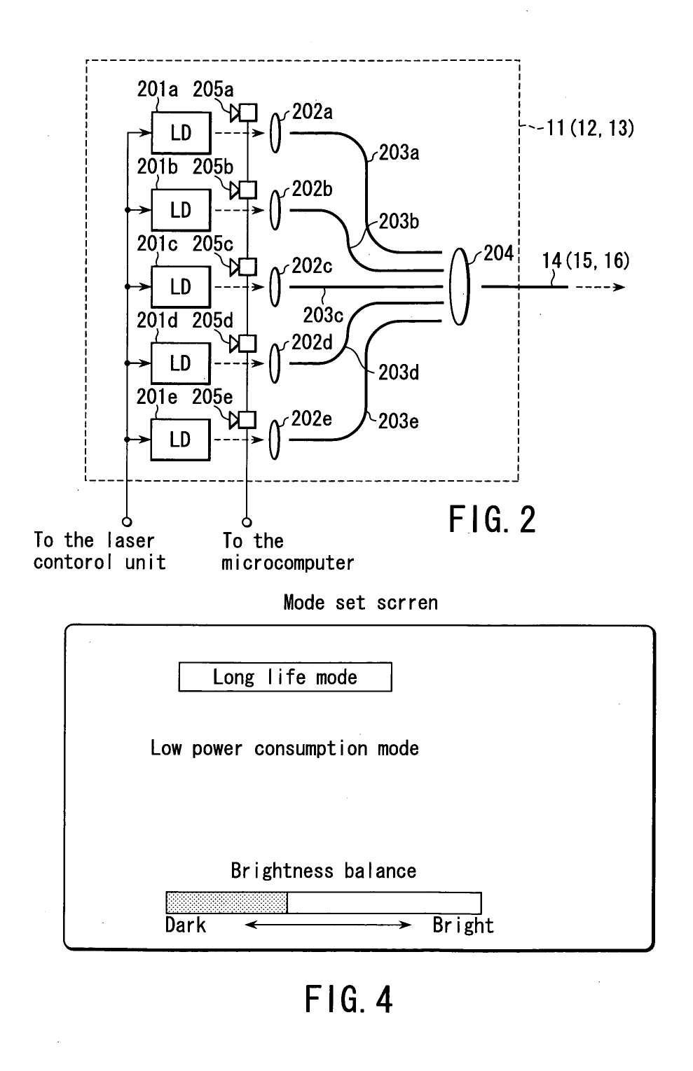

FIG. 1 shows an embodiment of a projection video display unit according to the present invention. FIG. 2 shows the configuration of a part of the unit of FIG. 1 in detail. In FIG. 1, a projection video display unit has a first to third optical modules 11 to 13 which emits red, green and blue laser beams, respectively. FIG. 2 shows a detailed configuration example of these optical modules 11-13. The optical modules can also be called laser output means including fibers 14, 15 and 16.

FIG. 2 shows the optical module 11, one of the optical modules 11-13. The configuration of the optical module 11 is the same as those of the optical modules 12 and 13, and the optical module 11 will be explained.

Reference numerals 201a-201e denote a semiconductor laser apparatus as a laser oscillator.

The lights outputted from the semiconductor laser apparatus 201a-201e are input to the corresponding optical fibers 203a-203e, respectively through optical parts 202a-202e. A lens or a light wave guide is used for the optical parts 202a-202e.

The lights input to the optical fibers 203a-203e are outputted and synthesized through an optical part 204. The synthesized light is input to one optical fiber 14. Reference numerals 205a-205e denote sensors to measure the strength or quantity of light outputted from the semiconductor laser apparatus 201a-201e. For example, a photodiode or CCD is used as the sensors.

The sensors 205a-205e are preferably arranged not to obstruct entrance of the laser beams emitted from the semiconductor laser apparatus 201a-201e to the optical parts 202a-202e. There are several methods of arranging the sensors 205a-205e. For example, since a part of emitted laser beam spreads radially and includes an ineffective part that does not enter an optical part, it is possible to place a sensor in this ineffective part. Alternatively, since there is laser beam leakage at the rear of the laser apparatus opposite to the laser output part, it is also possible to place a sensor in this part.

Returning to FIG. 1, light R, light G and light B synthesized by the optical modules 11, 12 and 13, respectively are applied to lenses 17, 18 and 19, and become parallel lights. The lights R, G and B outputted from the lenses 17, 18 and 19 are applied to liquid crystal panels 23, 24 and 25 as corresponding spatial modulation elements through polarizing filters 20, 21 and 22. The liquid crystal panels 23, 24 and 25 are arranged on three input surfaces of a dichroic prism 26. The liquid crystal panels 23, 24 and 25 spatially modulate the lights R, G and B according to video signals.

The R, G and B video signals obtained by spatial modulation are synthesized by the dichroic prism 26, outputted as color video signals and applied to a projection lens unit 27. The color video signals emitted from the projection lens unit 27 are projected onto a screen 28.

The liquid crystal panels 23, 24 and 25 are driven by the video signals from a liquid crystal drive unit 30. Video signals from an input terminal group 29 for R, G and B are applied to the liquid crystal drive unit 30. The liquid crystal drive unit 30 supplies the video signals corresponding to R, G, and B to the corresponding liquid crystal panels 23, 24 and 25 under the control of a microcomputer 32. The microcomputer 32 obtains timing signals for horizontal synchronization and vertical synchronization from the crystal drive unit 30.

Measurement signals from the sensors in the optical modules 11, 12 and 13 are taken into the microcomputer 32. Sensors 205a-205e in the representative optical module 11 are explained in FIG. 2. The microcomputer 32 obtains the output to determine the laser control state according to these measurement signals, and gives this output to a laser control unit 31. The laser control unit 31 controls the laser output state of each semiconductor laser apparatus in each optical module 11, 12 and 13, according to the output from the microcomputer 32.

The microcomputer 32 is operated by the output from an external remote control receiver 33. The remote control receiver 33 receives the operation signal from a not-shown remote controller, and gives the operation signal to the microcomputer 32.

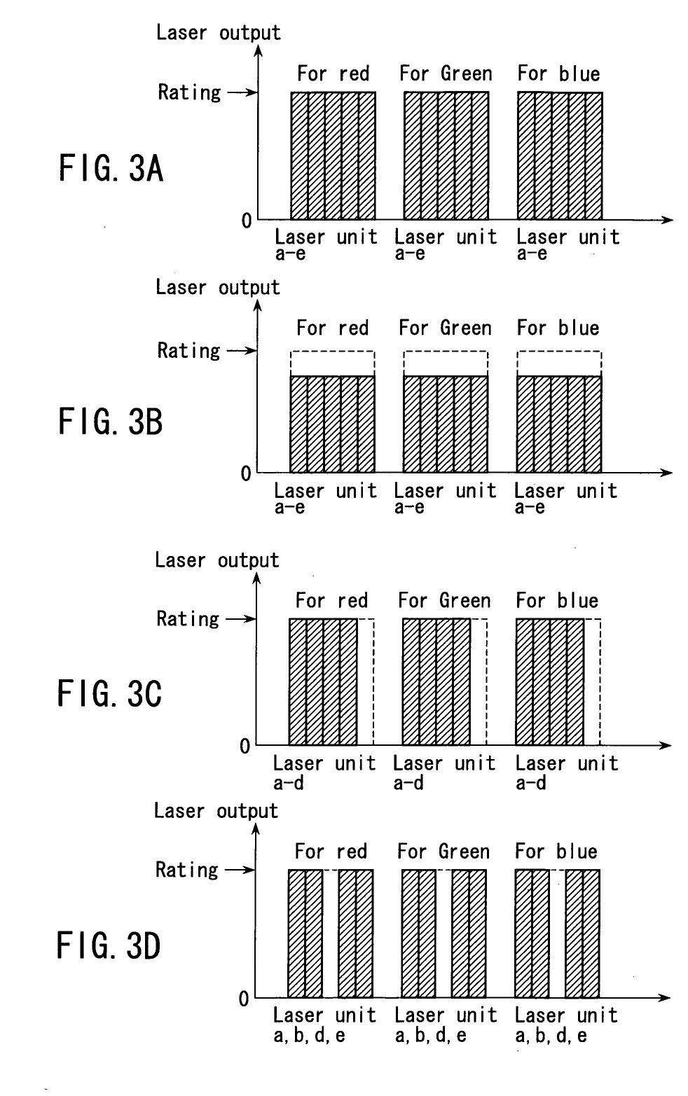

Next, explanation will be given on an example of control of an optical module that is the essential part of the present invention, with reference to FIG. 3A to FIG. 3D. This control example is for the case of decreasing the brightness of a display image when a semiconductor laser is used as a light source. The brightness of a display image is decreased for adjustment to make the life long and make the power consumption small, or adaptation to the brightness of the surroundings.

FIG. 3A shows the state that the outputs of all semiconductor laser apparatus of red, green and blue optical modules are obtained with uniform ratings. FIG. 3B shows the case of decreasing the outputs of all semiconductor laser apparatus of red, green and blue optical modules. This is suitable for the purpose of making the life long. It is preferable to operate a semiconductor by a low power output for obtaining a long life.

FIG. 3C shows the case of stopping one semiconductor laser apparatus of the red, green and blue optical modules. This is suitable for the purpose of decreasing the power consumption of the semiconductor laser apparatus.

One semiconductor laser apparatus has a threshold value for a drive voltage. When a plurality of semiconductor laser apparatuses are simultaneously driven, the total electric power consumed for the threshold values of each semiconductor laser apparatus is included in the total power consumption. Namely, a semiconductor laser apparatus obtains an optical output disproportionate to the power consumption, and consumes more power if an oscillation threshold value is exceeded. Therefore, when decreasing the power consumption, the power consumption can be made smaller by turning off one or more semiconductor laser apparatuses, rather than reducing the total output, as shown in FIG. 3B. Further, though a semiconductor laser apparatus to be stopped is fixed in the method of FIG. 3C, it is permitted to change a semiconductor laser apparatus a-e to be stopped sequentially and periodically. FIG. 3D shows the state that another semiconductor laser apparatus c is stopped.

FIG. 4 shows an example of a menu screen to select a long life mode by the control state of FIG. 3B or a low power consumption mode by the control state of FIG. 3C. For example, “Long Life Mode” or “Low Power Consumption Mode” is displayed on OSD (On Screen Display) and selected by a cursor.

When the long life mode is selected on the OSD, the microcomputer 32 lowers the outputs of the red, green and blue optical modules 11-13 to hold the balance as shown in FIG. 3B, through the laser control unit 31. By the lowering the outputs, the life of the optical modules 11-13 can be made long.

When the low power consumption mode is selected on the OSD, the microcomputer 32 stops the output of the semiconductor laser apparatus 201e of each optical module 11-13 as shown in FIG. 3C, through the laser control unit 31. By stopping the output, the power consumption can be lowered by the quantity equivalent to three semiconductor laser apparatuses in the optical modules 11-13.

The menu screen of FIG. 4 is displayed by selecting the display mode key of a remote controller, for example. The cursor can be moved by the arrow key of a remote controller. When the user's desired mode is specified by the cursor and the set key is operated, the desired mode is set.

It is possible to provide the unit of the present invention with a marginal luminance measurement mechanism for measuring the marginal luminance, so as to control the brightness accordingly. Namely, it is permitted to adjust the brightness by the luminance information from the marginal luminance measurement mechanism, and at the same time automatic control of the optical module outputs is possible based on the light quantity information from the sensors 205a-205e which measure the optical output of the optical modules 11-13. Further, the optical module outputs can be controlled manually.

When an observer wants to reduce the brightness of display image manually, the observer adjusts the adjustment bar on the screen, for example, and sets the optical modules 11-13 to one of the control states of FIG. 3B, FIG. 3C and FIG. 3D by selecting the long life mode or low power consumption mode. It is also permitted to operate by monitoring the menu screen on the OSD when changing the mode manually.

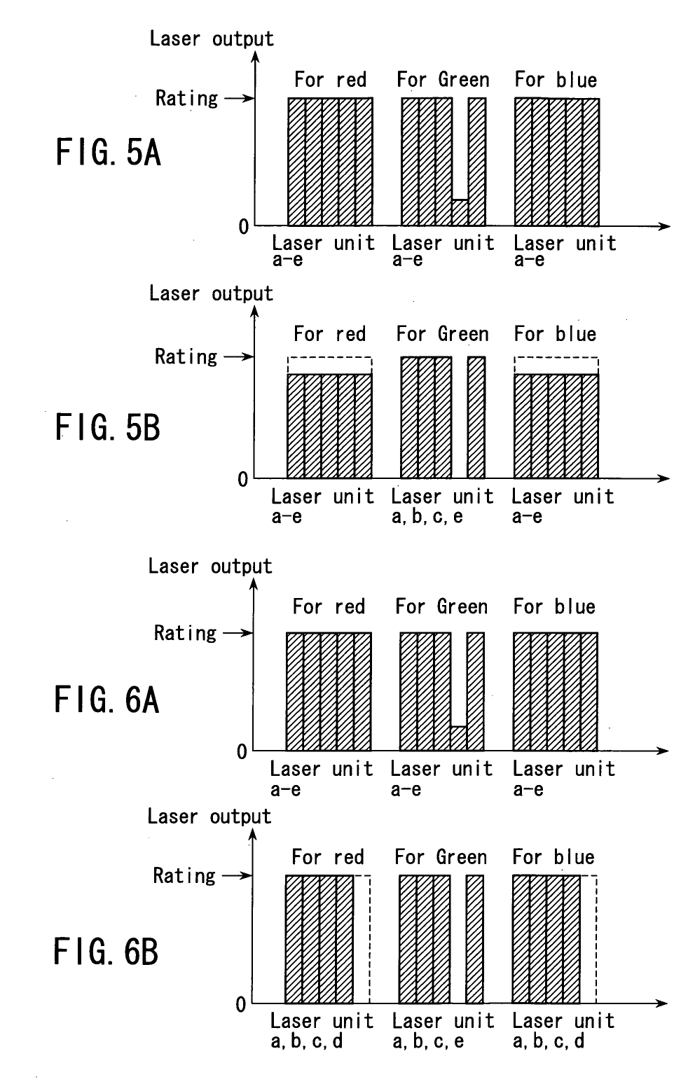

Explanation will be given on another example of optical module control with reference to FIG. 5A and FIG. 5B or FIG. 6A and FIG. 6B. This control is used to make correction if a semiconductor laser apparatus of the optical module fails in the normal mode.

FIG. 5A and FIG. 5B and FIG. 6A and FIG. 6B show the case that the semiconductor laser apparatus 201d of the green optical module 12 fails. The output of the semiconductor laser apparatus 201d is lowered. In this case, the operation of the semiconductor laser apparatus 201d of the green optical module 12 is stopped (refer to FIG. 5B and FIG. 6B), and the output of the red and blue optical modules 11 and 13 is lowered according to the lowered output of the green optical module 12 to get the white balance.

FIG. 5A and FIG. 5B show the case that the outputs of all semiconductor laser apparatuses 201a-201d in the red and green optical modules 11 and 13 are lowered. This is suitable for the purpose of making the life long. This operation will automatically take the control state shown in the drawings, when the unit of the present invention is set to the long life mode.

FIG. 6A and FIG. 6B show the case that the semiconductor laser apparatus 201d of the red and blue optical modules 11 and 13 are stopped. This is suitable for the purpose of lowering the power consumption. In this case, the operation will automatically take the control state shown in the drawings, when the unit of the present invention is set to the low power consumption mode.

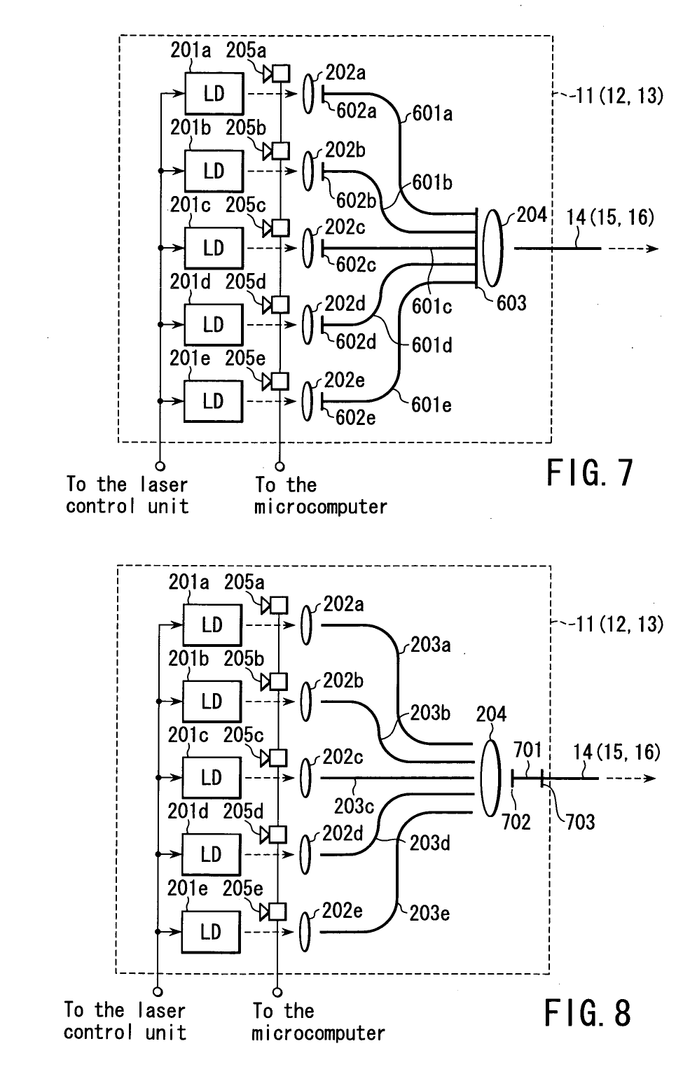

FIG. 7 shows a detailed configuration of an optical module for explaining another embodiment of the present invention, when a fiber laser mechanism is incorporated in each optical module 11-13. Same reference numerals are given to the same components as those in the configuration of FIG. 2.

In FIG. 7, reference numerals 601a-601e denote optical fibers with a laser active material added in the core. Reflection elements 602a-602e are provided at the input ends of the optical fibers 601a-601e. These reflection elements 602a-602e transmit the lights of the laser apparatus 201a-201e, and reflect the lights generated in resonance optical fibers 601a-601e.

In the case of the red optical module 11, the reflection elements 602a-602e reflect light having red wavelengths and permit transmission of light of the other wavelengths (including the green and blue wavelengths). In the case of the green optical module 12, the reflection elements 602a-602e reflect light having green wavelengths and permit transmission of light of the other wavelengths (including the red and blue wavelengths). In the case of the blue optical module 13, the reflection elements 602a-602e reflect light having blue wavelengths and permit transmission of light of the other wavelengths (including the red and green wavelengths).

A reflection element 603 is provided at the output ends of the resonance optical fibers 601a-601e. This reflection element 603 reflects a part of the lights generated in the resonance optical fibers 601a-601e, and transmits a part of them.

In the case of the red optical module 11, reflection element 603 reflects part of red-wavelength light, permits transmission of the remaining part thereof, and totally reflects green-wavelength light and blue-wavelength light. In the case of the green optical module 12, reflection element 603 reflects part of green-wavelength light, permits transmission of the remaining part thereof, and totally reflects red-wavelength light and blue-wavelength light. In the case of the blue optical module 13, reflection element 603 reflects part of blue-wavelength light, permits transmission of the remaining part thereof, and totally reflects red-wavelength light and green-wavelength light.

The lights outputted from a plurality of semiconductor laser apparatus 201a-201e are applied to a plurality of resonance optical fibers 601a-601e through the optical parts 202a-202e. The semiconductor laser apparatus 201a-201e need not output a color laser beam. The lights applied to the resonance optical fibers 601a-601e act upon the core material in the resonance optical fibers 601a-601e as an excitation light, and optical pumping and absorption are performed there.

Resonance optical fibers 601a-601e generate red light in the case of the red optical module 11, generates green light in the case of the green optical module 12, and generates blue light in the case of the blue optical module 13.

Namely, the light exited by the incident light forms a resonator and becomes a laser beam between reflection elements 502a-503e and reflection element 503, and passes through the reflection element 603.

Each of the resonance optical fibers 601a-601e acts as a fiber laser mechanism, and the output lights are synthesized by the optical part 204, and applied to the optical fiber 14.

As described above, in the fiber laser mechanisms 131a (201a, 202a, 601a, 602a, 603)-131e (201e, 202e, 601e, 602e, 603), a laser active material added to the resonance optical fiber, the oscillation wavelength of the semiconductor laser, the reflectivity of the reflection elements, etc. are determined to obtain red, green and blue laser beams.

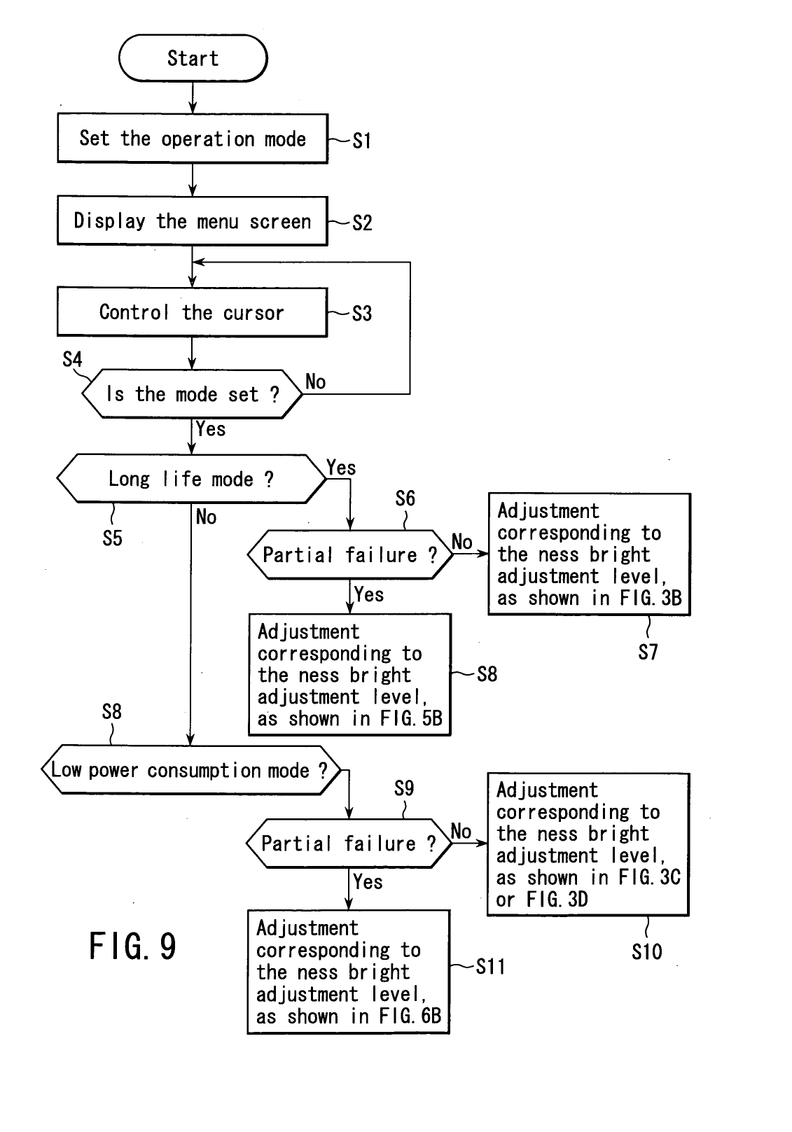

FIG. 8 shows a detailed configuration of an optical module for explaining another embodiment of the present invention, when a fiber laser is incorporated in each optical module 11-13. The same reference numerals are given to the same components as those in FIG. 2.

In FIG. 8, a reference numeral 701 denotes a resonance optical fiber with a laser active material added in a core. A reference numeral 702 denotes a reflection element which transmits the lights of the semiconductor laser apparatus 201a-201e, and reflects the light generated by the resonance optical fiber 701. A reference numeral 703 denotes a reflection element which reflects a part of the light generated by the resonance optical fiber 701, and transmits a part of it.

In this case, the lights outputted from the semiconductor laser apparatus 201a-201e are synthesized by the optical parts 202a-201e, optical fibers 203a-203e, and optical part 204. The synthesized light is applied as an excitation light to the resonance optical fiber 701, and forms a resonator between the reflection elements 702 and 703. The resonance optical fiber 701 forms a fiber laser mechanism, and the generated laser beam is outputted from the reflection element 603.

As described above, in the red optical module 11, a laser active material added to the resonance optical fiber, the oscillation wavelength of the semiconductor laser, the reflectivity of the reflection elements, etc. are determined to obtain red laser beam by fiber laser mechanisms (201a-201e, 202a-202e, 203a-203e, 204, 701, 702, 703). In the green and blue optical modules 12 and 13, a laser active material added to the resonance optical fiber, the oscillation wavelength of the semiconductor laser, the reflectivity of the reflection elements, etc. are determined to obtain green and blue laser beams.

The method of controlling the semiconductor laser apparatus 201a-201e shown in FIG. 7 and FIG. 8 is the same as that shown in FIG. 3A-FIG. 3D, FIG. 5A and FIG. 5B or FIG. 6A and FIG. 6B, and the explanation will be omitted. The present invention is not limited to the above-mentioned embodiments. The invention is applicable to a single color light source comprising a plurality of laser apparatuses, for example, although the light source comprises red, green and blue lights in FIG. 1.

FIG. 9 shows an example of control routine for the case that an operation mode is set in the unit of the present invention. This control routine is obtained by operating the microcomputer 32 through a remote controller. When an operation mode set key is operated, a menu screen is displayed (step S1, S2). A cursor is moved on the screen to set a desired brightness and operation mode (long life mode and low power consumption mode) (step S3, S4).

If a long life mode is set (step S5), a plurality of laser oscillators is checked for errors (step S6). If no error is detected, the operation is moved to the control state shown in FIG. 3B (step S6) and finished. In this case, if the brightness is adjusted, the preset quantity of light is decreased in addition to the brightness adjustment. If an error is detected, the operation is moved to the control state shown in FIG. 5B (step S7) and finished. In this case, also, if the brightness is adjusted, the preset quantity of light is decreased in addition to the brightness adjustment.

If the long life mode is not set in step S5, whether the low power consumption is being set is checked (step S8). In this case, also, a plurality of laser oscillators is checked for an error (step S9). If no error is detected, the operation is moved to the control state shown in FIG. 3C (step S10) and finished. In this case, if the brightness is adjusted, the preset quantity of light is decreased in addition to the brightness adjustment. If an error is detected, the operation is moved to the control state shown in FIG. 6B (step S11) and finished. In this case, also, if the brightness is adjusted, the preset quantity of light is decreased in addition to the brightness adjustment.

As described above, in the present invention, the laser outputs from a plurality of laser output means (11, 12, 13) and laser oscillators (201a-201e) are synthesized, and the synthesized single optical output is obtained. When the long life mode is set, the control means (31, 32) lowers the whole optical output by adjusting the outputs of all of the laser oscillators (201a-201e) of the plurality of laser output means (11, 12, 13).

Further, in the present invention, when the low power consumption mode is set, the control means (31, 32) lowers the whole optical output by stopping the optical outputs of some of the laser oscillators (201a-201e) in the plurality of laser output means (11, 12, 13).

Further, the present invention realizes a projection video display unit which modulates R (red), G (green) and B (blue) lights by spatial modulation elements, synthesizes the modulated lights, and projects the synthesized light and forms an image on a screen by using an optical means. In this unit, the laser output means (11, 12, 13) for the R (red), G (green) and B (blue) lights obtain a single output synthesized with the laser outputs from a plurality of laser oscillators (201a-201e). And, a stage of detectors (205a-205e) is provided in each laser output means, and detects the quantity of the light outputted from the plurality of laser oscillators (201a-201e). When an error occurs in some of the laser oscillators in the laser output means (11, 12, 13), the control means (31, 32) lowers the optical outputs of all laser oscillators in the non-failed laser output means for the other colors (11, 12 or 13), decreases the brightness of the display image, and maintains the balance of R, G and B optical outputs.

Further, When an error occurs in some laser oscillators in the laser output means (11, 12, 13), the control means (31, 32) stops the optical output of some laser oscillators in the non-failed laser output means for the other colors (11, 12 or 13), decreases the brightness of a display image, and keeps the balance of R, G and B optical outputs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A laser apparatus comprising:
a plurality of laser output means, each laser output means obtaining a single optical output synthesized with the laser outputs from a plurality of laser oscillators; and
control means, the control means lowering the whole optical output by adjusting the optical outputs of all of said plurality of laser oscillators of said plurality of laser output means, when a long life mode is set, and lowering the whole optical output by stopping the outputs of some of said plurality of laser oscillators in said plurality of laser output means, when a low power consumption mode is set.

2. A laser apparatus comprising:
a plurality of laser output means, each laser output means obtaining a single optical-output synthesized with the laser outputs from a plurality of laser oscillators;
detection means provided in each laser output means, and detecting the quantity of the light outputted from said plurality of laser oscillators; and
control means specifying one of said plurality of laser output beams based on the detection outputs of the detection means, and decreasing the brightness of the light outputted from the specified laser output beams by adjusting the optical outputs of all of said plurality of laser oscillators.

3. A laser apparatus comprising:
a plurality of laser output means, each laser output means obtaining a single optical output synthesized with the laser outputs from a plurality of laser oscillators;
detection means provided in each laser output means, and detecting the quantity of the light outputted from said plurality of laser oscillators; and
control means specifying one of said plurality of laser output beams based on the detection outputs of the detection means, and decreasing the brightness of the light outputted from the specified laser output beams by adjusting the optical outputs of some of said plurality of laser oscillators.

4. The laser apparatus according to claim 1, wherein the laser apparatus is used as a light source of R, G and B lights in a projection video display unit; and the control means maintains the balance of R, G and B optical outputs.

5. The laser apparatus according to claim 2, wherein the laser apparatus is used as light sources of R, G and B lights in a projection video display unit; and the control means maintains the balance of R, G and B optical outputs.

6. The laser apparatus according to claim 3, wherein the laser apparatus is used as light sources of R, G and B lights in a projection video display unit; and the control means maintains the balance of R, G and B optical outputs.

7. The laser apparatus according to any one of claims 1-3, wherein the laser output unit includes a plurality of resonance optical fibers with a laser active material added in a core; and said plurality of laser oscillators pump sources of the corresponding said plurality of resonance optical fibers.

8. The laser apparatus according to any one of claims 1-3, wherein the laser output unit includes a single resonance optical fiber with a laser active material added in a core; and the outputs of said plurality of laser oscillators are synthesized and applied as an excitation light of a resonance optical fiber.

9. A projection video display unit which modulates R (red), G (green) and B (blue) lights in space modulation elements, synthesizes the space modulated lights, and projects the synthesized light and forms an image on a screen by using an optical means, comprising:
laser output means for the R (red), G (green) and B (blue) lights, each laser output means obtaining a single optical output synthesized with the laser outputs from a plurality of laser oscillators;
detection means provided in each laser output means, and detecting the quantity of the light outputted from said plurality of laser oscillators; and
control means, the control means lowering the optical outputs of all of the laser oscillators in the non-failed laser output means for the other colors, decreasing the brightness of a display image, and maintaining the balance of R, G and B optical outputs, when an error occurs in any of the laser oscillators in the laser output means.

10. A projection video display unit which modulates R (red), G (green) and B (blue) lights in space modulation elements, synthesizes the space modulated lights, and projects the synthesized light and forms an image on a screen by using an optical means, comprising:
laser output means for the R (red), G (green) and B (blue) lights, each laser output means obtaining a single optical output synthesized with the laser outputs from a plurality of laser oscillators;
detection means provided in each laser output means, and detecting the quantity of the light outputted from said plurality of laser oscillators; and
control means stopping the optical outputs of some of the laser oscillators in the non-failed laser output means for other colors, decreasing the brightness of a display image, and keeping the balance of R, G and B optical outputs, when an error occurs in any laser oscillator in the laser output means.

11. A projection video display unit which modulates R (red), G (green) and B (blue) lights in space modulation elements, synthesizes the space modulated lights, and projects the synthesized light and forms an image on a screen by using an optical means, comprising:
laser output means for the R (red), G (green) and B (blue) lights, each laser output means obtaining a single optical output synthesized with the laser outputs from a plurality of laser oscillators;
detection means provided in each laser output means, and detecting the quantity of the light outputted from said plurality of laser oscillators; and
control means lowering the optical outputs of all of the laser oscillators in the non-failed laser output means for the other colors, decreasing the brightness of a display image, and keeping the balance of R, G and B optical outputs, when an error occurs in some laser oscillators in the laser output means, when a long life mode is set, and stopping the optical outputs of some of the laser oscillators in the non-failed laser output means for the other colors, decreasing the brightness of a display image, and maintaining the balance of R, G and B optical outputs, when an error occurs in a laser oscillator in the laser output means, when a low power consumption mode is set.
